(19) United States
(12) Patent Application Publication
(10) Pub. No.: US 2015/0006571 A1
(43) Pub. Date: Jan. 1, 2015

(54) Method And Apparatus For Enabling Queries In An Information-Centric Network

(71) Applicants: LGS Innovations LLC, Herndon, VA (US); Alcatel-Lucent USA Inc., Murray Hill, NJ (US)

(72) Inventors: Matteo Varvello, Port Monmouth, NJ (US); Lloyd G. Greenwald, Murray Hill, NJ (US)

(73) Assignees: LGS Innovations LLC, Herndon, VA (US); Alcatel-Lucent USA Inc., Murray Hill, NJ (US)

(21) Appl. No.: 13/930,641

(22) Filed: Jun. 28, 2013

(51) Int. Cl. G06F 17/30

(52) U.S. Cl. CPC G06F 17/30545
USPC 707/770

(57) ABSTRACT

Various embodiments provide a method and apparatus for providing queries in an information-centric network. In particular, the content is identified by a name that includes discrete components that identify the participating caching nodes within a network. Caching nodes store a reference to the content and are configured to provide the address of the node(s) providing the requested content.

### TECHNICAL FIELD

The invention relates generally to methods and apparatus for providing queries in an information-centric network.

### BACKGROUND

This section introduces aspects that may be helpful in facilitating a better understanding of the inventions. Accordingly, the statements of this section are to be read in this light and are not to be understood as admissions about what is in the prior art or what is not in the prior art.

In some known query solutions within an information-centric network, a node within a network of nodes requests content by sending a request to all nodes within the network to return the results of a query performed locally on each node.

### SUMMARY OF ILLUSTRATIVE EMBODIMENTS

Some simplifications may be made in the following summary, which is intended to highlight and introduce some aspects of the various exemplary embodiments, but such simplifications are not intended to limit the scope of the inventions. Detailed descriptions of a preferred exemplary embodiment adequate to allow those of ordinary skill in the art to make and use the inventive concepts will follow in later sections.

Various embodiments provide a method and apparatus for providing queries in an information-centric network. In particular, the content is identified by a name that includes discrete components that identify the participating caching nodes within a network. Caching nodes store a reference to the content and are configured to provide the address of the node(s) providing the requested content.

In a first embodiment, an apparatus is provided for providing queries in an information-centric network. The apparatus includes a data storage and a processor communicatively connected to the data storage. The processor is programmed to: select an announce content; determine a plurality of select content segments based on the announce content; determine a plurality of resolver nodes based on the plurality of content segments; and transmit a plurality of announce messages directed to corresponding ones of the plurality of resolver nodes.

In a second embodiment, a method is provided for providing queries in an information-centric network. The method including: selecting an announce content; determining, by the processor in cooperation with the data storage, a plurality of select content segments based on the announce content; determining, by the processor in cooperation with the data storage, a plurality of resolver nodes based on the plurality of content segments; and transmitting, by the processor in cooperation with the data storage, a plurality of announce messages directed to corresponding ones of the plurality of resolver nodes.

In a third embodiment, a non-transitory computer-readable storage medium is provided for storing instructions which, when executed by a computer, cause the computer to perform a method. The method includes: selecting an announce content; determining a plurality of select content segments based on the announce content; determining a plurality of resolver nodes based on the plurality of content segments; and transmitting a plurality of announce messages directed to corresponding ones of the plurality of resolver nodes.

In some of the above embodiments, determination of the plurality of resolver nodes comprises geographic hashing of ones of the plurality of select content segments to determine corresponding ones of the plurality of resolver nodes.

In some of the above embodiments, the transmission of the announce messages comprises GPSR.

In some of the above embodiments, the information-centric network is a MANET.

In some of the above embodiments, the data storage comprises a content portion comprising a first set of content hosted by the apparatus and a cache portion comprising a set of content pointers. Where the set of content pointers identify a second set of content hosted by a corresponding plurality of host nodes in the information-centric network.

In some of the above embodiments, the processor is further programmed or the method further includes: receiving an announce message; determining that the apparatus has resolver node status for a resolver content referenced in the announce message; determining one or more resolver content pointers based on the announce message, the one or more resolver content pointers identifying the resolver content and a resolver content host node hosting the resolver content; and caching the one or more resolver content pointers in the data storage.

In some of the above embodiments, the processor is further programmed or the method further includes: switching-over resolver node status from a resolver node to a neighbor node based on a determination that the neighbor node is closer to the resolver content host node than the resolver node.

In some of the above embodiments, the processor is further programmed or the method further includes: transmitting the announce message to a plurality of secondary resolver nodes.

In some of the above embodiments, the processor is further programmed or the method further includes: determining one or more query content pointers based on a query content; determining a resolver node based on the one or more query content pointers; transmitting a content query to the resolver node, the content query being based on the one or more content pointers; and receiving the query content.

In some of the above embodiments, the reception of the query content comprises performing a fetch operation directed to a query host node hosting the query content.

In some of the above embodiments, the processor is further programmed or the method further includes: receiving a second content query; retrieving one or more second query content pointers from the data storage; and transmitting a content response to a query node based on the second content query and the one or more second query content pointers.

In some of the above embodiments, the processor is further programmed or the method further includes: receiving a second content query; determining that the data storage does not contain second query content pointers corresponding to the second content query; determining one or more second query resolver nodes based on the second content query; transmitting a resolution message to a select one of the one or more second query resolver nodes; receiving a response message comprising one or more second query content pointers; and transmitting a content response to a query node based on the second content query and the one or more second query content pointers.

### BRIEF DESCRIPTION OF THE DRAWINGS

Various embodiments are illustrated in the accompanying drawings, in which:

FIG. 1 illustrates an embodiment of an information-centric network 110 for providing queries for content hosted on one or more of the nodes 120-1-120-n (collectively, nodes 120);

FIG. 2 schematically illustrates a node 220 that is an embodiment of one of nodes 120 of FIG. 1;

FIG. 3 depicts a flow chart illustrating an embodiment of a method 300 for a host node (e.g., node 120-1 of FIG. 1) to announce hosting of a content to other nodes within the network (e.g., network 110 of FIG. 1);

FIG. 4 depicts a flow chart illustrating an embodiment of a method 400 for a resolver node (e.g., node 120-1 of FIG. 1) to configure resolution of content within the network (e.g., network 110 of FIG. 1);

FIG. 5 depicts a flow chart illustrating an embodiment of a method 500 for a query node (e.g., node 120-1 of FIG. 1) to request content within the network (e.g., network 110 of FIG. 1);

FIG. 6 depicts a flow chart illustrating an embodiment of a method 600 for a resolver node (e.g., node 120-3 of FIG. 1) to respond to a content query from a query node (e.g., node 120-1 of FIG. 1); and

FIG. 7 schematically illustrates an embodiment of various apparatus 700 such as one of nodes 120 of FIG. 1.

To facilitate understanding, identical reference numerals have been used to designate elements having substantially the same or similar structure or substantially the same or similar function.

### DETAILED DESCRIPTION OF ILLUSTRATIVE EMBODIMENTS

The description and drawings merely illustrate the principles of the invention. It will thus be appreciated that those skilled in the art will be able to devise various arrangements that, although not explicitly described or shown herein, embody the principles of the invention and are included within its scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, the various embodiments described herein are not necessarily mutually exclusive, as some embodiments may be combined with one or more other embodiments to form new embodiments.

As used herein, the term, “or” refers to a non-exclusive or, unless otherwise indicated (e.g., “or else” or “or in the alternative”). Furthermore, as used herein, words used to describe a relationship between elements should be broadly construed to include a direct relationship or the presence of intervening elements unless otherwise indicated. For example, when an element is referred to as being “connected” or “coupled” to another element, the element may be directly connected or coupled to the other element or intervening elements may be present. In contrast, when an element is referred to as being “directly connected” or “directly coupled” to another element, there are no intervening elements present. Similarly, words such as “between”, “adjacent”, and the like should be interpreted in a like fashion.

Various embodiments provide a method and apparatus for providing queries in an information-centric network. In particular, the content is identified by a name that includes discrete components that identify participating nodes that cache pointers to the content (i.e., resolver nodes) within a network. Resolver nodes store a reference to the content and are configured to provide the address of the node(s) providing the requested content (i.e., the host node).

Advantageously, by configuring the discrete components of the name to identify nodes resolver nodes, the information-centric network may scale to larger networks than a system that floods the network to determine the location of the host node.

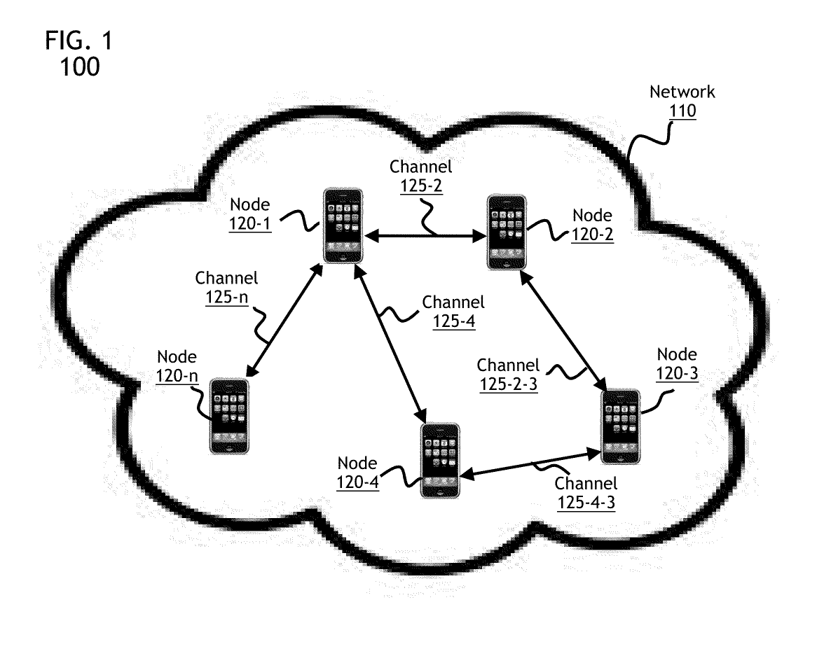

FIG. 1 illustrates an embodiment of an information-centric network 110 for providing queries for content hosted on one or more of the nodes 120-1-120-n (collectively, nodes 120). Nodes 120 communicate to each other via one or more of channel 125-2, 125-2-3, 125-4, 125-4-3, or 120-n (collectively, channels 125).

As defined herein, an “information-centric network” is broadly construed as a network where access and delivery of information, or content, is provided by using content names as addresses.

Nodes 120 may include any type of communication device(s) capable of hosting content or requesting content from other nodes within network 110 by sending or receiving information (e.g., packets) via one or more of channels 125. For example, a communication device may be a thin client, a smart phone, a personal or laptop computer, server, network device, tablet, television set-top box, media player or the like. It should be appreciated that while five nodes are illustrated here, system 100 may include fewer or more nodes. Moreover, the number of nodes at any one time may be dynamic as nodes may be added or subtracted from the system at various times during operation or one or more nodes may change their location or activity status.

Channels 125 support communicating over one or more communication channels such as: wireless communications (e.g., LTE, GSM, CDMA, Bluetooth); WLAN communications (e.g., WiFi); packet network communications (e.g., IP); broadband communications (e.g., DOCSIS and DSL); storage communications (e.g., Fibre Channel, iSCSI) and the like. It should be appreciated that though depicted as a single connection, communication channels 125 may be any number or combinations of communication channels.

In some embodiments, information-centric network 110 is a sensor network. In some of these embodiments, multiple sensors are distributed in order to collect information such temperature, humidity or alarm information.

In some embodiments, information-centric network 110 is a Mobile Ad hoc NEtwork (MANET). As defined herein, a “MANET” is broadly construed as a collection of wireless nodes that communicate in the absence of a fixed infrastructure.

In some of these embodiments, the MANET is used to provide communication during battlefield or emergency disaster relief operations.

In some embodiments, nodes 120 are configured to communicate to one or more neighbor nodes. For example, node 120-1 may be capable of communicating with nodes 120-2, 120-4 and 120-n. In some of these embodiments, nodes 120 maintain a list of neighbor nodes.

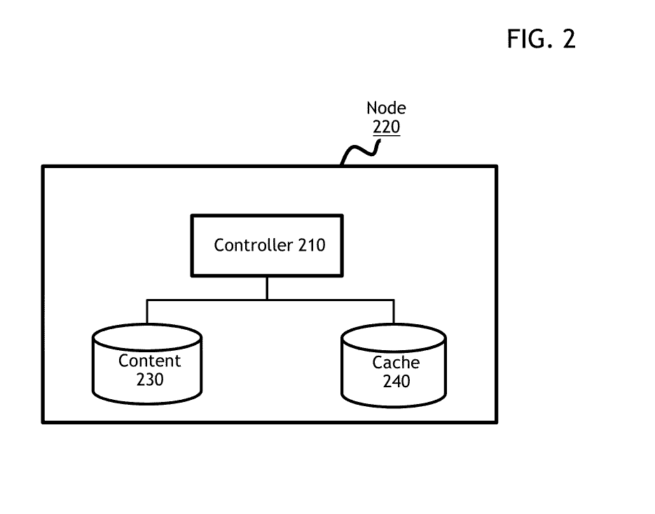

FIG. 2 schematically illustrates a node 220 that is an embodiment of one of nodes 120 of FIG. 1. The node 220 includes a controller 210 that is communicatively connected to content 230 and cache 240.

Controller 210 is configured for hosting content or requesting content in an information-centric network. In particular, a node is configured to perform one or more of the following operations:
Announce: advertise the availability of hosted content;
Query: locate the node(s) where requested content resides; and
Fetch: retrieve a requested content.

Content 230 stores the content (e.g., video feed, an image or a sensor reading) for which node 220 is a host node. Content may be any set of bytes identified by a name, e.g., a video feed, an image or a sensor reading. In particular, the content name has “B” components where the components refer to an attribute. For example, the name “/belllabs/video/22_{—}23/video_{—}1/” contains four components delimited by the “/” character: (i) “belllabs”; (ii) “video”; (iii) “22_{—}23”; and (iv) “video_{—}1” and describes the content as owned by “belllabs”, being a “video” and created between 22 and 23 hours.

Cache 240 stores the content pointers associated with one or more content items. Content pointers may be any suitable format that identifies the location of the host node for the content or a resolver node associated with the address components.

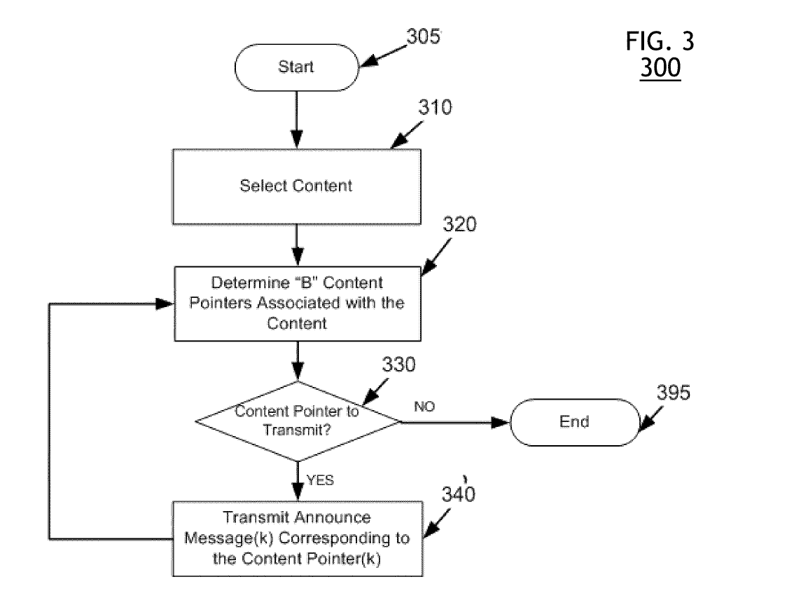

FIG. 3 depicts a flow chart illustrating an embodiment of a method 300 for a host node (e.g., node 120-1 of FIG. 1) to announce hosting of a content to other nodes within the network (e.g., network 110 of FIG. 1). The method begins at step 305 and includes: selecting a content (step 310); determining the “B” content pointers associated with the content (step 320); and transmitting “B” announce messages corresponding to the “B” content pointers (step 340) until a determination is made that there are no more content pointers to transmit (step 330). The method ends at step 395.

In the method 300, step 310 includes selecting a content hosted by a node to announce availability of the content to other nodes of the network (e.g., one of nodes 120 announcing to other of nodes 120 in network 110 of FIG. 1). Selection of the content may by any suitable method such as for example, (i) based on collection of the content (e.g., a recently taken picture or video or a content retrieved from another node); (ii) based on a request from another node regarding the content hosted by the node; (iii) based on a periodic announcement of the availability of the content; or (iv) based on an exchange with a resolver node (e.g., determining that a resolution node does not have the content pointer in its cache as described herein).

In the method 300, step 320 includes determining the “B” content pointers associated with select components of the content. In particular, content pointers are determined based on one or more corresponding content components of the content. For example, for a content having address: “belllabs/video/22_{—}23/video_{—}1/”, the node may select one or more of the components “belllabs”, “video”, “22_{—}23”, or “video_{—}1” and determine content pointers corresponding to the selected content components. It should be appreciated that the node may determine not to select all of the components.

In the method 300, step 330 includes determining whether announce messages have been transmitted for each of the selected “B” content pointers. If there remains an announce message to transmit, the method proceeds to step 330, else the method proceeds to step 395 and ends.

In the method 300, step 340 includes transmitting an announce message corresponding to one of the “B” content pointers to a resolver node based on the corresponding content pointer. Announce messages may be any suitable format that contains a node identifier, a location identifier and the content pointer. In particular, the node identifier and location identifier are configured such that the node associated with the content pointer may be found within the network. Furthermore, the content pointer is configured such that the resolver node may be determined from the content pointer. A node identifier may be any suitable parameter that identifies the node associated with the content pointer (e.g., the host node for content referenced by the content pointer). For example, a node identifier may be a node ID or an IP address. A location identifier may be any suitable parameter that identifies the location of the node identified by the node identifier. For example, a location identifier may be GPS coordinates.

In some embodiments of the step 340, the resolver node is determined based on a hash of the corresponding content component.

In some embodiments of the step 340, the hashing is geographic hashing. In some of these embodiments, the hash provides a pair of coordinates in a Cartesian space. In some of these embodiments, the Cartesian space is geocentric and includes longitude and latitude dimensions. Advantageously, since geographic hashing generates evenly distributed Cartesian points, for a uniform distribution of nodes in the network, the B resolution nodes may be evenly distributed.

In some of these embodiments, the location identifier reflects the current geographic coordinates of the node and thusly, the location identifier may change according to the node's mobility.

In some embodiments of the step 340, announce messages are routed using geographic routing such as GPSR. In particular, the node informs the node whose coordinates are the closest to the content pointer to cache the content pointer(s) (e.g., to provide resolver node functionality).

Advantageously, geographic routing allows for routing to a node using a location identifier or to a host or resolver node using a content pointer.

In some embodiments of the step 340, the announce message contains the pair <content name, node identifier, location identifier>. In some of these embodiments the location identifier is the current coordinates of the host node.

In some embodiments of the step 340, the announce message is forwarded via GPSR to the resolver node having a location estimated to be closest to the location identifier.

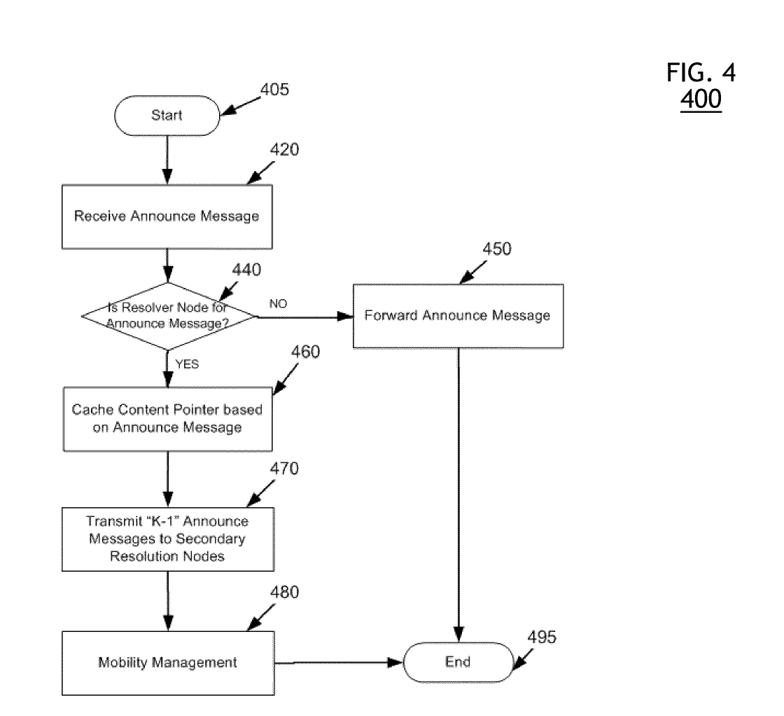

FIG. 4 depicts a flow chart illustrating an embodiment of a method 400 for a resolver node (e.g., node 120-1 of FIG. 1) to configure resolution of content within the network (e.g., network 110 of FIG. 1). The method begins at step 405 and includes: receiving an announce message (step 420) and determining whether the node performing the method is the resolver node for the received announce message (step 440). If the node is not the resolver node, the node optionally forwards the announcement message (e.g., using GPRS) (step 450), else the method continues to step 460. If the node is the resolver node, the resolver node caches the content pointer based on the received announce message (step 460); optionally transmits the announce message to K−1 secondary nodes (step 470) and optionally performs mobility management (step 480). The method ends at step 495.

In the method 400, step 420 includes receiving an announce message (e.g., an announce message transmitted in step 340 of FIG. 3). In particular, the announce message is received and the announce information such as content name, location identifier or node identifier is extracted from the message.

The method 400 optionally includes steps 440 and 450. In step 440, a determination is made whether the location identifier of the node performing the method matches a location identifier of a target resolver node. The location identifier of the target resolver node is based on the content name extracted from the announce message. It should be appreciated that a match of the location identifiers does not need to be exact and only requires an estimation that the location of the node performing the method is the closest of the selected nodes within the network (e.g., the closest of nodes 120 in network 110 of FIG. 1) to the location identifier of the target resolver node. If the receiving node is not determined to be the closest node, the node may forward the announce message to another node in step 450, else the method continues to step 460. For example, referring to FIG. 1, assuming that node 120-1 transmits an announce message that contains a content segment to which node 120-3 is closest to the location identifier of the target resolver node, if node 120-2 receives an announce message from node 120-1 via channel 125-2, node 120-2 may forward the announce message to node 120-3 via channel 125-2-3.

In the method 400, step 460 includes caching the content pointer based on the received announce message (e.g., storing the content pointer(s) in cache 240 of FIG. 2). In particular, information is stored which enables the resolver node to identify the host node serving content identified by the content name (e.g., the node identifier and location identifier associated with the content pointer).

The method 400 optionally includes step 470. Step 470 includes transmitting the announce message to K−1 secondary resolver nodes. In particular, the primary resolver node (i.e., the closest node to the target resolver node) may configure additional secondary resolver nodes. Advantageously, if the primary resolver node is not available (e.g., moved or the status changed), the announce message may be resolved by one of the secondary resolver nodes.

The method 400 optionally includes step 480. Step 480 includes performing mobility management. In particular, the node performing the method monitors its neighbors to determine whether one of its neighbors is closer to the location identifier of the target resolver node and if so, the node may initiate a switchover between itself (i.e., the current resolver node) and the neighbor determined to be closer (i.e., the new resolver node). As defined herein, a “closer determination” is broadly construed as including a threshold buffer (e.g., determining when the neighbor node is closer than {the current resolver node−distance_{threshold}} in order to avoid frequent switchovers).

In some embodiments of the method 400, the location identifier of the target resolver node is based on one or more select content segment(s) of the content name. In some of these embodiments, the location identifier of the target resolver node is based on a geographic hashing of the select content segment(s) as described above. For example, the location identifier of an announce message including a parameter of {content name=“/belllabs/video/22_{—}23/video_{—}1/”} may determine a location identifier of the target resolver node based on: hash(“belllabs”) or hash(“belllabs/video”).

In some embodiments of the step 460, the content pointers are stored in a table. In some of these embodiments, the content pointers are the received content name, location identifier and node identifier extracted from the announce message. In some of these embodiments, the table has the content name as a key and the pair <node identifier, location identifier> as a value. In some of these embodiments, if an entry with the same key and node identifier already exists, the location identifier information is updated.

In some of the embodiments of the step 470, the primary resolver node (e.g., the node performing the method) selects the K−1 nodes among its neighbors that are the closest to the location identifier of the target resolver node and forwards then the announce message or a modified announce message (e.g., having an indication that the announce message is for a secondary resolver node). In a further embodiment, if the primary resolver node has less than K−1 neighbors, the primary resolver node retrieves neighbor nodes corresponding to one or more of the neighbor nodes of the primary resolver node.

In some embodiments of the step 480, the current resolver node determines whether the new resolver node is already a resolution node for the content identified by the content name. If the new resolver node is not a resolver node for the content identified by the content name already, the current resolution node transfers the content pointers for the content to the new resolution node and configures itself to be a regular node (e.g., delete the content pointers from its own cache). If the new resolver node is a resolver node for the content, the current resolver node may configure itself to be a regular node or perform no further actions.

In some embodiments of the step 480, if a new resolver node receives more than one switchover request to the same content, the new resolver node selects one of the switchover requests (e.g., by a random selection or first in queue selection) to perform the switchover, and informs the remaining resolver nodes requesting a switchover that it is a resolver node already.

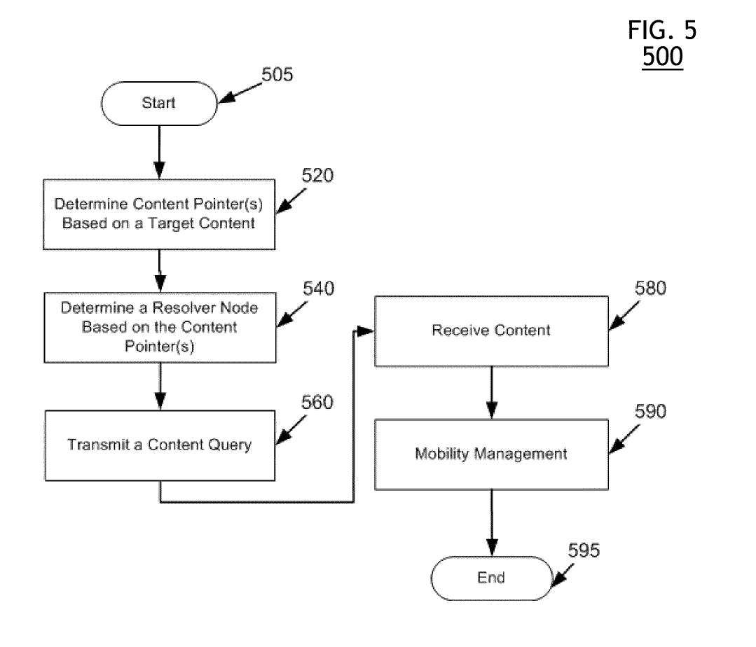

FIG. 5 depicts a flow chart illustrating an embodiment of a method 500 for a query node (e.g., node 120-1 of FIG. 1) to request content (e.g., “/belllabs/video/22_{—}23/video_{—}1/”) within the network (e.g., network 110 of FIG. 1). The method begins at step 505 and includes: determining content pointer(s) based on a target content (step 520); determining a resolver node based on the content pointer(s) (step 540); transmitting a content query (step 560); receiving the content (step 580); and optionally performing mobility management (step 590). The method ends at step 595.

In the method 500, step 520 includes determining content pointer(s) based on a target content. Target content may be either a specific content (e.g., “/belllabs/video/22_{—}23/video_{—}1/”) or one or more content components (e.g., all bell labs videos “/belllabs/video/” or all sensor readings between a temperature range such as 33-99° F.). Target content may be selected using any suitable method such as: (i) identified by a user (e.g., using a GUI); (ii) identified by an application (e.g., an application compiling sensor readings between a selected temperature); or (iii) the like. Content pointers may be the content components or any other suitable information that may be used to identify the location of the resolver node(s).

In the method 500, step 540 includes determining a resolver node based on the content pointer(s). In particular, the location identifier of at least one of the content components is determined as described herein (e.g., by perform geographic hashing on the at least one of the content components).

In the method 500, step 560 includes transmitting a content query based on the location identifier determined in step 540. In particular, a content query is addressed to a resolver node and contains suitable information for the resolver node to query its cache and determine the location identifier of the host node for the target content.

In the method 500, step 580 includes receiving the requested content. The query node may receive the requested content via any suitable method such as: (i) receiving a location identifier of the host node from the resolver node and subsequently querying the host node directly; (ii) receiving the content from the resolver node; (iii) receiving the content from the host node via a request from the resolver node forwarded on behalf of the query node; or (iv) the like.

The method 500 optionally includes step 590. Step 590 includes performing mobility management. In particular, a host node may move without re-announcing its location identifier to the resolver nodes. Thus, the query node performing the content retrieval in step 580 may fail. As such, any suitable operation may be initiated by the query node to re-establish the location identifier of the host node.

In some embodiments of the step 540, the location identifier is a set of Cartesian coordinates (e.g., latitude and longitude).

In some embodiments of the step 540, location identifiers are determined for more than one of the content components. In some of these embodiments, the target location identifier is selected from the set of determined location identifiers. In some of these embodiments, the target location identifier is selected based on a calculated shortest distance between the location identifier of the query node (i.e., the node performing the method 500) and the target location identifier as compared to the other location identifiers in the set. For example, for an m-dimension range query (e.g., “/belllabs/video/”, where m=2) the content components “belllabs” and “video” may be hashed to determine location identifiers (e.g., Cartesian coordinates) for the resolver node for “belllabs” and the resolver node for “video” and the shortest distance between the query node is resolved by the closest resolution node.

In some embodiments of the step 540, the location identifier is based on multi-dimensional parameters such as more than one content component.

In some embodiments of the step 540, the location identifier is based on a range. In some of these embodiments, the resolver node which is the closest to the target resolver location splits the requested range into M ranges, and computes the M content pointers. Where the target resolver location is the derived location associated with the particular one or more content components, such as, for example, the location determined from a geographic hash of a content component. The resolver node then forwards a resolution message to a second resolver node that is the closest among the location identifiers associated with the computed M content pointers. Where a resolution message is similar to an announce message in that it provides a resolver node the necessary information to configure itself as a resolver node, with the difference being that a resolution message originates from a node other than the host node such as a resolver node. It should be appreciated that the second resolver node may be responsible for content requests which are part of a larger range than the requested one. It should be further appreciated that since the cached data range may be larger than the queried data range, the second resolver node may require additional processing to resolve the query as compared to a simple table lookup.

Referring to FIG. 1, an example of a multi-dimensional range query where node 120-1 aims to retrieve all videos published between 22 and 23 hours, (i.e., “/video/22_{—}23/”). Node 120-1 computes a location (e.g., hash(“/video/22_{—}23/”)) and sends a query message addressed to the location (e.g., to which node 120-2 is closest) containing </video/22 23/, node identifier[node 120-1], location identifier[node 120-1]>. The query message reaches node 120-2, the geographically closest node to node 120-1, via GPSR; however, node 120-2 is not configured to answer the query as no announcement for this specific range was previously received. Node 120-2 uses the requested range to derive location “n” (e.g., to which node 120-n is closest)=hash(/video/) and location “3” (e.g., to which node 120-3 is closest)=hash(/22_{—}23/); and forwards the query to the closest location (e.g., location “3”). In the example, a query message is forwarded to node 120-3 which is the geographically closest node to node 120-2 via GPSR. Node 120-3 is responsible for the range /22_{—}23/ and thus, has content pointers for all of the content in the network that was generated between 22 and 23 hours cached, including videos. Node 120-3 may then extract the video content between the range of 22_{—}23, (e.g., “/belllabs/video/22_{—}23/video_{—}1/” which is for example, hosted by node 120-4). Finally, node 120-3 responds to both node 120-1 and 120-2 with the set of information matching the range including, content <“/belllabs/video/22_{—}23/video_{—}1/”, node identifier[node 120-4], location identifier[node 120-4]>. Node 120-2 uses this set of information for future range queries, and node 120-1 uses this set of information to fetch content in the desired range.

Advantageously, multidimensional location identifiers may resolve frequently used multi-dimensional queries more efficiently. In some of these embodiments, the creation of a multi-dimensional location identifier is based on query popularity or data aggregation.

In some embodiments of the step 560, the content query includes the tuple <content name, node identifier, location identifier>.

In some embodiments of the step 560, the content query is forwarded to the target resolver node via GPSR.

In some embodiments of the step 560, the query may be either point query or range query. As defined herein, a “point query” is broadly construed as a query to retrieve a specific content (e.g., “/belllabs/video/22_{—}23/video_{—}1/”). As defined herein, a “range query” is broadly construed as a query to retrieve all records with an attribute that has values between an upper and lower boundary. It should be appreciated that a range query may be a multi-dimensional range query (e.g., extended to multiple attributes).

In some embodiments of the step 580, the received content may be a NULL value. For example, the resolver may return a NULL value if: (i) no host node has yet announced for the target content; or (ii) the announce information associated with the content pointer was lost or corrupted. It should be appreciated that a content pointer may be lost or corrupted due to node mobility, adverse network conditions or node failures.

In some embodiments of the step 580, a fetch operation is used to retrieve a content from a host node. In some of these embodiments, the fetch operation is performed via a fetch message addressed to a host node identified by the tuple <node identifier[host node]; location identifier[host node]> and additionally contains the tuple <content name, node identifier[fetch node], location identifier[fetch node]> where node identifier[fetch node] and location identifier[fetch node] describe the node identifier and location identifier of the node performing the fetch operation. The fetch message may be delivered to the host node using GPSR and location identifier[host node] as the destination. The fetched content traverses the network back to the fetch node using GPSR and the location identifier[fetch node] as the destination.

In some embodiments of the step 590, local flooding is performed. In particular, a fetch message is forwarded to the last available location of a host node and local flooding is initiated by the network nodes with mobility management capabilities closest to the location identifier of the host node if the host node is not found. The closest node to first checks its neighbors searching for the host node and then if the host node is still not found, may request those neighbor nodes to search for the host node amongst their neighbor list. This search operation may recursively search neighbor nodes until the host node is found or after a maximum number of hops or searches are reached. In some of these embodiments, once a node has located the host node, the node updates the initiating resolver node and optionally one or more of the other resolver nodes with the most recent location identifier of the host node. It should be appreciated that if only one resolver node (e.g., the closest resolver node to the query node) is updated, the re-announce operation will result in fewer network messages.

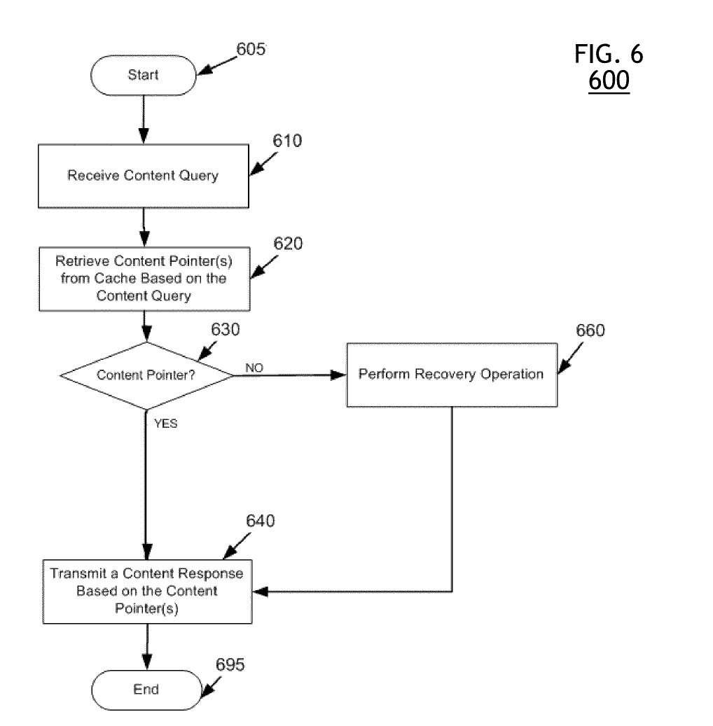

FIG. 6 depicts a flow chart illustrating an embodiment of a method 600 for a resolver node (e.g., node 120-3 of FIG. 1) to respond to a content query from a query node (e.g., node 120-1 of FIG. 1). The method begins at step 605 and includes: receiving a content query (step 610); retrieving content pointer(s) from the cache based on the content query (step 620); and if no content pointers are retrieved, proceeding to step 660, else proceeding to step 640 and transmitting a content response based on the content pointer(s) (step 640). If no content pointer(s) are retrieved the method optionally includes performing a recovery operation (step 660). The method ends at step 595.

In the method 600, step 610 includes receiving a content query. In particular, the content query contains suitable information for the resolver node performing the method to retrieve the content pointers from its cache.

In the method 600, step 620 includes retrieving content pointer(s) from the cache based on the content query. In particular, the resolver node performing the method uses the content name as a key into the cache to extract any suitable information that enables a node to fetch the content from the host node. For example, the content pointer(s) may include the node identifier[host node] and location identifier[host node].

In the method 600, step 630 includes determining if content pointers were retrieved in step 620. If no content pointers were retrieved, the method optionally proceeds to step 660, else the method proceeds to step 630.

In the method 600, step 640 includes transmitting a content response based on the content pointer(s). The content response may include any suitable information that enables the query node to receive the content. Suitable information may include: (i) the retrieved content pointers; (ii); the content itself retrieved by the resolver node; or (iii) a request to the host node to provide the content to the query node.

The method optionally includes step 660. Step 660 includes performing a recovery operation. In particular, if the resolver node performing the method does not have content pointer(s) for the requested content, the resolver node performs any suitable operation such as: (i) configure step 640 to transmit an error response; (ii) attempt to retrieve the content pointer(s) from another resolver node, a secondary resolver node, or the host node; (iii) add an entry into the cache indicating that the host is unavailable; or (iv) the like.

In some embodiments of the step 640, the content response is delivered to the target node using GPSR. For example, to deliver a content response to the query node, GPSR uses the location identifier[query node] in the content response.

In some embodiments of the step 660, resolver node performing the method attempts to obtain the content pointer(s) from another resolver node. In particular, the node performing the method derives a list of other resolver nodes based on the content segments in the content name for which the node performing the method is not a resolver node. The node then issues a resolution message addressed to one of the other resolver nodes (e.g., the closest other resolver node).

In some of these embodiments, the resolution message includes a resolver node pointer list that identifies the resolver nodes that have already been queried for the content pointer(s). In some of these embodiments, other resolver nodes identified in the resolver node pointer list are excluded from the selection of the other resolver node to send the resolution message.

In some of these embodiments, the recovery operation continues until either the content pointer(s) to the host node are found or all the resolver node pointers are explored.

In some of these embodiments, the last contacted resolver node or the resolver node performing the method informs node informs the query node and one or more of the resolver nodes to either announce the new host node content pointer(s) or to inform the nodes that the content is unavailable. If the recovery procedure verifies that such content is unavailable, one or more of the nodes may add an entry in their local cache that explicitly indicates that the requested content has no host. Advantageously, future recovery operations related to nonexistent content may be avoided.

Although primarily depicted and described in a particular sequence, it should be appreciated that the steps shown in methods 300, 400, 500 and 600 may be performed in any suitable sequence. Moreover, the steps identified by one step may also be performed in one or more other steps in the sequence or common actions of more than one step may be performed only once.

For example, in the method 300, it should be appreciated that steps 320, 330 and 340 may be performed in any suitable manner. As one example, a determination of whether announce messages remain to be transmitted in step 330 may be performed at the same time as step 320. In this first example, the selection of content pointers may include creating a list of content points to which corresponding announce messages will be sent. In a second example, steps 330 and 340 may include sending all of the announce messages in parallel as opposed to serially as illustrated in the method flow.

It should be appreciated that steps of various above-described methods can be performed by programmed computers. Herein, some embodiments are also intended to cover program storage devices, e.g., data storage media, which are machine or computer readable and encode machine-executable or computer-executable programs of instructions, wherein said instructions perform some or all of the steps of said above-described methods. The program storage devices may be, e.g., digital memories, magnetic storage media such as a magnetic disks and magnetic tapes, hard drives, or optically readable data storage media. The embodiments are also intended to cover computers programmed to perform said steps of the above-described methods.

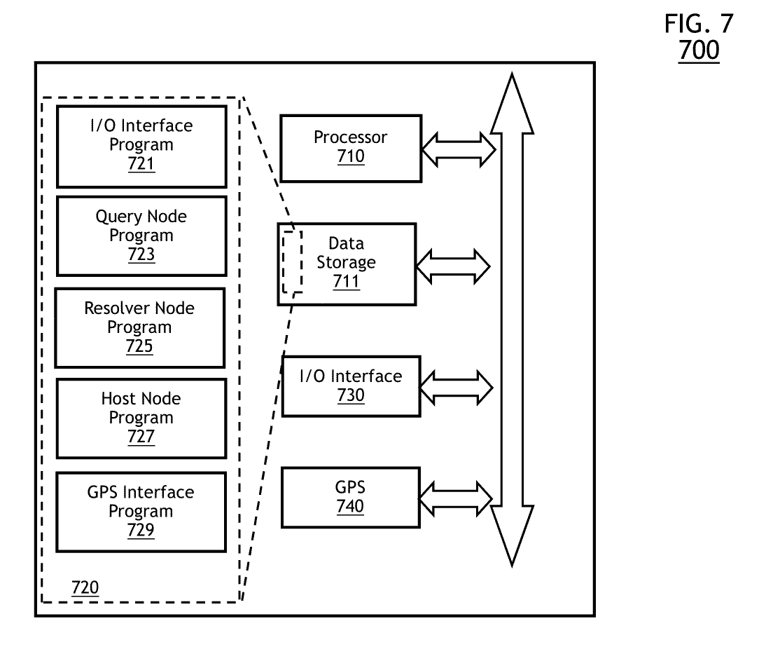

FIG. 7 schematically illustrates an embodiment of various apparatus 700 such as one of nodes 120 of FIG. 1. The apparatus 700 includes a processor 710, a data storage 711, optionally an I/O interface 730; and optionally a GPS 740.

The processor 710 controls the operation of the apparatus 700. The processor 710 cooperates with the data storage 711.

The data storage 711 stores programs 720 executable by the processor 710. Data storage 711 may also optionally store program data such as content 230 and cache 240 of FIG. 2, or the like as appropriate.

The processor-executable programs 720 may include an I/O interface program 721, a query node program 723, a resolver node program 725, a host node program 727 or a GPS interface program 729. Processor 710 cooperates with processor-executable programs 720.

The I/O interface 730 cooperates with processor 710 and I/O interface program 721 to support communications over channels 125 of FIG. 1 as described above. The I/O interface program 721 performs portions of one or more of the steps of 340 of FIG. 3; steps 420, 450, 470 or 480 of FIG. 4; steps 560, 580, or 590 of FIG. 5; or steps 610, 640 or 660 of FIG. 6 as described above and as appropriate.

The query node program 723 performs one or more of the steps of the method 500 of FIG. 5 as described above and as appropriate.

The resolver node program 725 performs one or more of the steps of the methods 400 of FIG. 4 or 600 of FIG. 6 as described above and as appropriate.

The host node program 727 performs one or more of the steps of the method 300 of FIG. 3 as described above and as appropriate.

The GPS 740 cooperates with processor 710 and GPS interface program 729 to support GPS functions as described above. The GPS interface program 729 performs portions of one or more of the steps of 340 of FIG. 3; steps 420, 450, 470 or 480 of FIG. 4; steps 560, 580, or 590 of FIG. 5; or steps 610, 640 or 660 of FIG. 6 as described above and as appropriate.

In some embodiments, the processor 710 may include resources such as processors/CPU cores, the I/O interface 730 may include any suitable network interfaces, or the data storage 711 may include memory or storage devices. Moreover the apparatus 700 may be any suitable physical hardware configuration such as: one or more server(s), blades consisting of components such as processor, memory, network interfaces or storage devices. In some of these embodiments, the apparatus 700 may include cloud network resources that are remote from each other.

In some embodiments, the apparatus 700 may be one or more virtual machine (s). In some of these embodiments, one or more of the virtual machine(s) may include components from different machines or be geographically dispersed. For example, the data storage 711 and the processor 710 may be in two different physical machines.

When processor-executable programs 720 are implemented on a processor 710, the program code segments combine with the processor to provide a unique device that operates analogously to specific logic circuits.

Although depicted and described herein with respect to embodiments in which, for example, programs and logic are stored within the data storage and the memory is communicatively connected to the processor, it should be appreciated that such information may be stored in any other suitable manner (e.g., using any suitable number of memories, storages or databases); using any suitable arrangement of memories, storages or databases communicatively connected to any suitable arrangement of devices; storing information in any suitable combination of memory(s), storage(s) or internal or external database(s); or using any suitable number of accessible external memories, storages or databases. As such, the term data storage referred to herein is meant to encompass all suitable combinations of memory(s), storage(s), and database(s).

The description and drawings merely illustrate the principles of the invention. It will thus be appreciated that those skilled in the art will be able to devise various arrangements that, although not explicitly described or shown herein, embody the principles of the invention and are included within its spirit and scope. Furthermore, all examples recited herein are principally intended expressly to be only for pedagogical purposes to aid the reader in understanding the principles of the invention and the concepts contributed by the inventor(s) to furthering the art, and are to be construed as being without limitation to such specifically recited examples and conditions. Moreover, all statements herein reciting principles, aspects, and embodiments of the invention, as well as specific examples thereof, are intended to encompass equivalents thereof.

The functions of the various elements shown in the FIGS., including any functional blocks labeled as “processors”, may be provided through the use of dedicated hardware as well as hardware capable of executing software in association with appropriate software. When provided by a processor, the functions may be provided by a single dedicated processor, by a single shared processor, or by a plurality of individual processors, some of which may be shared. Moreover, explicit use of the term “processor” or “controller” should not be construed to refer exclusively to hardware capable of executing software, and may implicitly include, without limitation, digital signal processor (DSP) hardware, network processor, application specific integrated circuit (ASIC), field programmable gate array (FPGA), read only memory (ROM) for storing software, random access memory (RAM), and non volatile storage. Other hardware, conventional or custom, may also be included. Similarly, any switches shown in the FIGS. are conceptual only. Their function may be carried out through the operation of program logic, through dedicated logic, through the interaction of program control and dedicated logic, or even manually, the particular technique being selectable by the implementer as more specifically understood from the context.

It should be appreciated that any block diagrams herein represent conceptual views of illustrative circuitry embodying the principles of the invention. Similarly, it should be appreciated that any flow charts, flow diagrams, state transition diagrams, pseudo code, and the like represent various processes which may be substantially represented in computer readable medium and so executed by a computer or processor, whether or not such computer or processor is explicitly shown.

What is claimed is:

1. An apparatus for providing queries in an information-centric network, the apparatus comprising:
a data storage; and
a processor communicatively connected to the data storage, the processor being configured to:
select an announce content;
determine a plurality of select content segments based on the announce content;
determine a plurality of resolver nodes based on the plurality of content segments; and
transmit a plurality of announce messages directed to corresponding ones of the plurality of resolver nodes.

2. The apparatus of claim 1, wherein determination of the plurality of resolver nodes comprises geographic hashing of ones of the plurality of select content segments to determine corresponding ones of the plurality of resolver nodes.

3. The apparatus of claim 1, wherein the transmission of the announce messages comprises GPSR.

4. The apparatus of claim 1, wherein the information-centric network is a MANET.

5. The apparatus of claim 1, wherein the data storage comprises a content portion comprising a first set of content hosted by the apparatus; and
a cache portion comprising a set of content pointers;
wherein the set of content pointers identify a second set of content hosted by a corresponding plurality of host nodes in the information-centric network.

6. The apparatus of claim 1, wherein the processor is further configured to:
receive an announce message;
determine that the apparatus has resolver node status for a resolver content referenced in the announce message;
determine one or more resolver content pointers based on the announce message, the one or more resolver content pointers identifying the resolver content and a resolver content host node hosting the resolver content; and
cache the one or more resolver content pointers in the data storage.

7. The apparatus of claim 6, wherein the processor is further configured to:
switch-over resolver node status from the apparatus to a neighbor node based on a determination that the neighbor node is closer to the resolver content host node than the apparatus.

8. The apparatus of claim 6, wherein the processor is further configured to:
transmit the announce message to a plurality of secondary resolver nodes.

9. The apparatus of claim 6, wherein the processor is further configured to:
determine one or more query content pointers based on a query content;
determine a resolver node based on the one or more query content pointers;
transmit a content query to the resolver node, the content query being based on the one or more content pointers; and
receive the query content.

10. The apparatus of claim 9, wherein the reception of the query content comprises configuring the processor to perform a fetch operation directed to a query host node hosting the query content.

11. The apparatus of claim 9, wherein the processor is further configured to:
receive a second content query;
retrieve one or more second query content pointers from the data storage; and
transmit a content response to a query node based on the second content query and the one or more second query content pointers.

12. The apparatus of claim 9, wherein the processor is further configured to:
receive a second content query;
determine that the data storage does not contain second query content pointers corresponding to the second content query;
determine one or more second query resolver nodes based on the second content query;
transmit a resolution message to a select one of the one or more second query resolver nodes;
receive a response message comprising one or more second query content pointers; and
transmit a content response to a query node based on the second content query and the one or more second query content pointers.

13. A method for providing queries in an information-centric network, the method comprising:
at a processor communicatively connected to a data storage, selecting an announce content;
determining, by the processor in cooperation with the data storage, a plurality of select content segments based on the announce content;
determining, by the processor in cooperation with the data storage, a plurality of resolver nodes based on the plurality of content segments; and
transmitting, by the processor in cooperation with the data storage, a plurality of announce messages directed to corresponding ones of the plurality of resolver nodes.

14. The method of claim 13, further comprising:
receiving, by the processor in cooperation with the data storage, an announce message;
determining, by the processor in cooperation with the data storage, that the apparatus has resolver node status for a resolver content referenced in the announce message;
determining, by the processor in cooperation with the data storage, one or more resolver content pointers based on the announce message, the one or more resolver content pointers identifying the resolver content and a resolver content host node hosting the resolver content; and
caching, by the processor in cooperation with the data storage, the one or more resolver content pointers in the data storage.

15. The method of claim 14, further comprising:
determining, by the processor in cooperation with the data storage, one or more query content pointers based on a query content;
determining, by the processor in cooperation with the data storage, a resolver node based on the one or more query content pointers;
transmitting, by the processor in cooperation with the data storage, a content query to the resolver node, the content query being based on the one or more content pointers; and
receiving, by the processor in cooperation with the data storage, the query content.

16. The method of claim 15, further comprising:
receiving, by the processor in cooperation with the data storage, a second content query;
retrieving, by the processor in cooperation with the data storage, one or more second query content pointers from the data storage; and
transmitting, by the processor in cooperation with the data storage, a content response to a query node based on the second content query and the one or more second query content pointers.

17. The method of claim 16, further comprising:
receiving, by the processor in cooperation with the data storage, a second packet from the edge router, the second packet comprising a server value identifying the virtual machine;
modifying, by the processor in cooperation with the data storage, a destination address of the second packet based on the server value; and
forwarding, by the processor in cooperation with the data storage, the second packet to the virtual machine.

18. A non-transitory computer-readable storage medium storing instructions which, when executed by a computer, cause the computer to perform a method, the method comprising:
selecting an announce content;
determining a plurality of select content segments based on the announce content;
determining a plurality of resolver nodes based on the plurality of content segments; and
transmitting a plurality of announce messages directed to corresponding ones of the plurality of resolver nodes.
